(19) United States
(12) Patent Application Publication
(10) Pub. No.: US 2025/0249300 A1
(43) Pub. Date: Aug. 7, 2025

(54) GAS FURNACE WITH FLAME ARRESTOR

(71) Applicant: Daikin Comfort Technologies Manufacturing, L.P., Waller, TX (US)

(72) Inventors: James Kistler, Houston, TX (US); Jianmin Zhang, Katy, TX (US)

(73) Assignee: Daikin Comfort Technologies Manufacturing, L.P., Waller, TX (US)

(21) Appl. No.: 19/040,803

(22) Filed: Jan. 29, 2025

Related U.S. Application Data
(60) Provisional application No. 63/641,607, filed on May 2, 2024.
(60) Provisional application No. 63/549,253, filed on Feb. 2, 2024.

(51) Int. Cl. A62C 4/02; F23M 11/02

(52) U.S. Cl. CPC A62C 4/02; F23M 11/02; F23M 2900/11021

(57) ABSTRACT

A gas furnace with a flame arrestor may be used for arresting a potential flame caused by ignition of refrigerant in gas furnaces. The flame arrestor may be attached to a housing of the gas furnace. The flame arrestor may include a plurality of holes configured to arrest a flame propagating out of an air intake pipe of the gas furnace.

### BACKGROUND

This section is intended to introduce the reader to various aspects of the art that may be related to various aspects of the presently described embodiments—to help facilitate a better understanding of various aspects of the present embodiments. Accordingly, it should be understood that these statements are to be read in this light, and not as admissions of prior art.

Many residential heating and cooling systems operate with A2L class refrigerants, and while some A2L refrigerants are considered to be more environmentally friendly compared to other classes of refrigerant, A2L refrigerants have a “mild flammability” classification. If an A2L refrigerant is exposed to the furnace's burners, an ignition may occur.

### SUMMARY

Certain aspects of one or more embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present disclosure generally relate to a gas furnace. One embodiment may include a gas furnace including a housing having a housing air intake, an air intake pipe connected to the housing air intake and having an intake end, and a flame arrestor connected to the intake end of the air intake pipe and having holes configured to arrest a flame propagating out of the air intake pipe.

In another embodiment, a kit may include a flame arrestor, an air intake pipe having a length of at least 150 mm, and an adapter configured to connect the flame arrestor and the air intake pipe.

In another embodiment, a method may include installing an air intake pipe, and securing a flame arrestor to the air intake pipe, the flame arrestor having holes configured to arrest a flame propagating out of the air intake pipe.

In another embodiment, a gas furnace may include a housing having louvers, and a plurality of flame arrestors covering the louvers wherein at least one of the flame arrestors includes a plurality of holes configured to arrest a flame propagating out of a louver.

In another embodiment, a method may include aligning a flame arrestor over a louver on a gas furnace and securing the flame arrestor to the gas furnace over the louver.

Certain disclosed embodiments may provide an installation kit including one or more flame arrestors for installation on a furnace.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of one or more embodiments without limitation to the claimed subject matter.

### BRIEF DESCRIPTION OF THE DRAWINGS

These and other features, aspects, and advantages of certain embodiments will become better understood when the following detailed description is read with reference to the accompanying drawings in which like characters represent like parts throughout the drawings.

FIG. 1 is a schematic illustration of a gas furnace with a single air intake, according to one or more embodiments.

FIG. 2 is a schematic illustration of a cylindrical flame arrestor, according to one or more embodiments.

FIG. 3 is a schematic illustration of a structure with a gas furnace installed, according to one or more embodiments.

FIG. 4 is an illustration of a structure with a gas furnace installed, according to one or more embodiments.

FIG. 5 is a schematic illustration of a gas furnace with louver air intakes, according to one or more embodiments.

FIG. 6 is a schematic illustration of a louver flame arrestor, according to one or more embodiments.

FIG. 7 is a schematic illustration of a gas furnace with a flame arresting burner enclosure, according to one or more embodiments.

FIG. 8 illustrates a gas furnace with a refrigerant sensor, according to one or more embodiments.

FIG. 9 is a schematic illustration of a control system configured to interface with a gas furnace, according to one or more embodiments.

FIG. 10 illustrates a flowchart for installing a flame arrestor, according to one or more embodiments.

FIG. 11 illustrates a flowchart for installing louver flame arrestors, according to one or more embodiments.

### DETAILED DESCRIPTION

One or more specific embodiments of the present disclosure will be described below. In an effort to provide a concise description of these embodiments, not all features of an actual implementation may be described. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements.

The present disclosure relates to devices and methods for arresting a potential flame caused by ignition of refrigerant in gas furnaces. For example, a flame arrestor may be attached to a housing of the gas furnace. The flame arrestor allows passage of a gas or gaseous mixture therethrough but interrupts or prevents passage of a flame. The arrestor thus prevents transmission of the flame through a flammable gas/air mixture by quenching the flame on a surface area provided with an array of small passages through which the flame must pass. The emerging gases are cooled enough to prevent ignition on the protected side. The various embodiments herein described include methods and devices for new furnaces or to modify existing gas furnaces to include flame arrestors on air intake sources, for example.

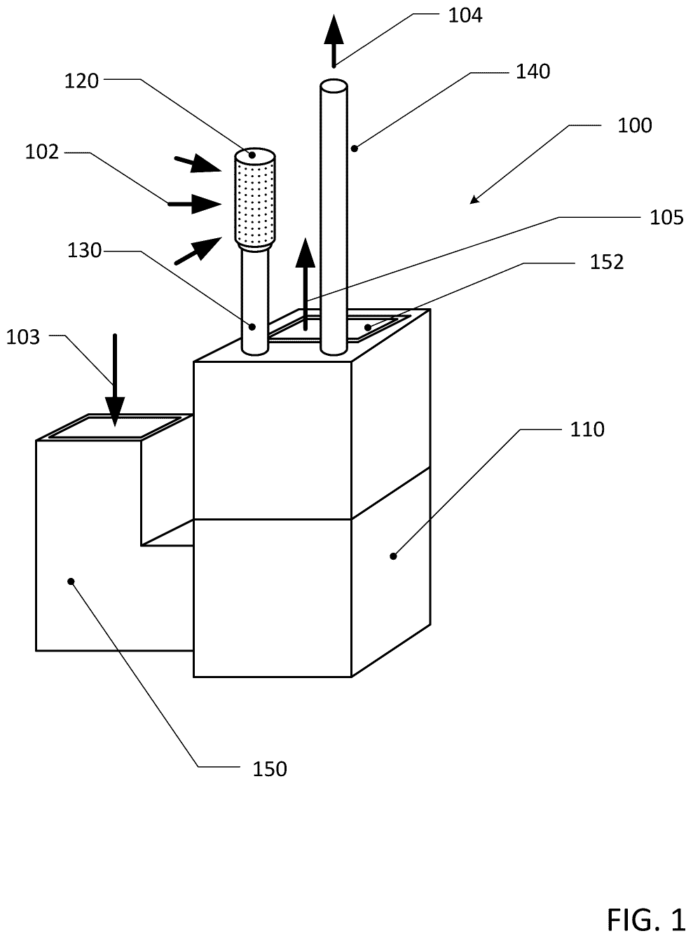

Turning now to the figures, FIG. 1 is an illustration of a residential gas furnace 100 with a single air intake having a flame arrestor 120 connected with an air intake pipe 130, according to one or more embodiments. The gas furnace may include other conventional structures, such as a housing 110, an exhaust flue 140, a circulation intake duct 150, a circulation outlet duct 152, a burner assembly (not shown), a heat exchanger (not shown), a fuel line (not shown), and other functional components. Combustion air 102 is drawn into the air intake pipe 130 from the surrounding environment as a source of oxygen for combustion of a fuel, such as gas, in the furnace 100. The combustion of the fuel produces heated combusted flue gases that flow through the furnace heat exchanger. Circulation air 103 from a space being heated, such as an indoor space, is drawn into the furnace 100 via circulation intake duct 150 and flows over the heat exchanger, which outputs heated air 105 through the circulation outlet duct 152 to flow back into the heated space and cools the combusted flue gases 104. The combusted flue gases 104 then flow through the exhaust flue 140.

Furnaces are typically located near an air-conditioning system that uses a refrigerant to exchange thermal energy with air inside the space being conditioned. In the event gaseous refrigerant and may be drawn into the furnace 100 through the intake pipe 130, the drawn-in refrigerant may ignite when exposed to an ignition source, resulting in a flame passing back through the air intake pipe 130 and spreading to potentially flammable materials surrounding the furnace 100. The flame arrestor 120 may be installed on the air intake pipe 130 to limit propagation of a flame. The flame arrestor 120 may be constructed of aluminum, steel, or other metal, or a thermally resistant material such as a ceramic, hard silicone, or heat-resistant plastic.

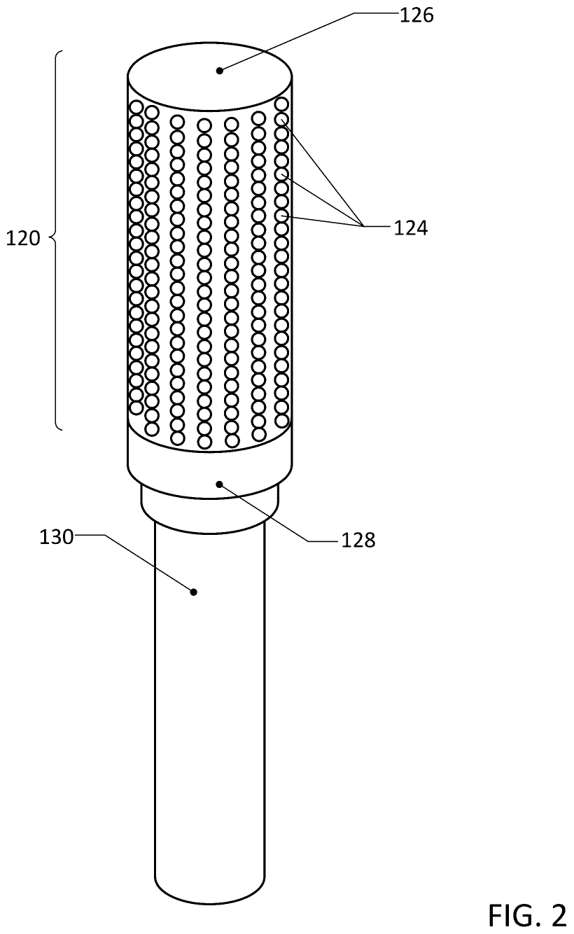

FIG. 2 illustrates an example flame arrestor 120 on an air intake pipe 130 in greater detail, according to one or more embodiments. As shown, the flame arrestor 120 includes a series of holes 124 disposed about the rounded surface of the flame arrestor 120. The holes 124 are configured to allow sufficient air movement through the flame arrestor 120 so as not to impair the combustion occurring in the furnace 100 during normal heating operations. The holes 124 are further configured to prevent a flame coming through the holes 124. The size and dispersal pattern of the holes 124 are determined based on the volumetric flowrate of air required to maintain combustion in the furnace 100 and the flammability of the refrigerant used in a corresponding heating, ventilation, and air conditioning (HVAC) system. As the flame arrestor may restrict airflow into the air intake pipe 130, it may be advantageous to have larger holes for the purposes of air intake, but advantageous to have smaller holes for flame arresting. In one or more embodiments, the air intake pipe 130 may intake air 102 by means of connection to a fan or air pumping system, the calibration of which may be adjusted to accommodate for changes in the volumetric flowrate due to flow restriction by the flame arrestor.

In one or more embodiments, a diameter of the holes 124 may be in a range of 0.5 millimeters (mm) to 30 mm. In one or more embodiments, the diameter of the holes 124 may be in a range of 1 mm to 10 mm. In one or more embodiments, the diameter of the holes 124 may be in a range of 2 mm to 7 mm. In one or more examples, such as for use with R-454B refrigerant, the diameter of the holes is less than 7 mm. In one or more examples, such as for use with R-32 refrigerant, the diameter of the holes 124 is less than 2.8 mm.

In one or more embodiments, a center-to-center distance between the holes 124, relative to the diameter of the holes 124 is in a range of 100% to 1000%. In one or more embodiments, the center-to-center distance between the holes 124, relative to the diameter of the holes 124 is in a range of 150% to 300%.

The flame arrestor 120 further includes a cap 126 at an end distal from the connection with the air intake pipe 130. In some embodiments, the cap 126 may not include holes. In other embodiments, the cap 126 may include holes 124. The flame arrestor 120 may be installed vertically with respect to a central axis of the flame arrestor 120 and the cap 126 may be installed horizontally (relative to gravity considered vertical). In that case, the cap 126 does not include holes to ensure all holes 124 for air intake are oriented perpendicular to gravity. In this manner, dust contained in the air 102 does not settle on the cap 126 and clog the holes therethrough. In one or more embodiments, the cap 126 is selectively removable or openable. In one or more embodiments, the cap 126 is permanently secured to the flame arrestor 120.

According to one or more embodiments, the flame arrestor 120 is attached to the air intake pipe 130 via an adapter 128. In other embodiments, the flame arrestor 120 includes threaded connectors and is threaded into or onto the adapter 128. In other embodiments, the flame arrestor 120 is secured to the adapter 128 by an adhesive. The adapter 128 may be secured to the air intake pipe 130 via a threaded connection, adhesive, or other suitable means of connection. In some embodiments, the connections between the air intake pipe 130, the adapter 128, and the flame arrestor 120 may be sealed to prevent air passing through the connections.

According to one or more embodiments, the flame arrestor 120 may be in the form of a kit. The kit may include a flame arrestor 120, a compatible pipe for the single air intake pipe 130, and one or more fasteners, adhesives, gaskets, or sealants for the flame arrestor 120 and intake pipe 130 to be installed on either a new or existing furnace 100.

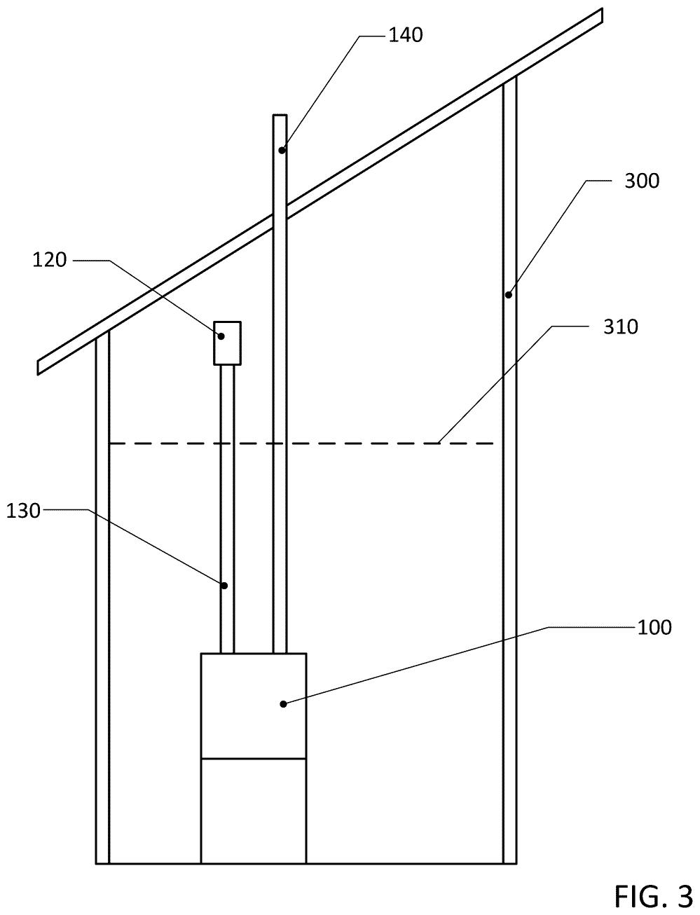

FIG. 3 illustrates a residential gas furnace 100 with a single air intake pipe 130 disposed inside of a structure 300. A flame arrestor 120 is disposed inside of the structure 300. A Low Flammable Limit (LFL) height 310 indicates the height at which a concentration of refrigerant—which may be heavier than air—in the air within the structure 300 would not be high enough to ignite. For example, if a refrigerant leak from an HVAC system occurred within the structure 300, the refrigerant, if heavier than air, would sink or fall below the LFL height 310. Thus, a concentration of the leaked refrigerant in the air below the LFL height 310 may be high enough to ignite if drawn into the intake pipe 130 and exposed to an open flame. However, the concentration of the same leaked refrigerant in the air above the LFL height 310 would not be high enough to ignite if drawn into the intake pipe 130 and exposed to the open flame. To prevent the refrigerant from being drawn into the intake pipe 130, the air intake pipe 130 may be of sufficient length to elevate the intake point of the air intake pipe 130 and at least part of the flame arrestor 120 above the LFL height 310.

According to one or more embodiments, the length of the air intake pipe 130 required to raise the air intake point above the LFL height 310 is at least 150 mm.

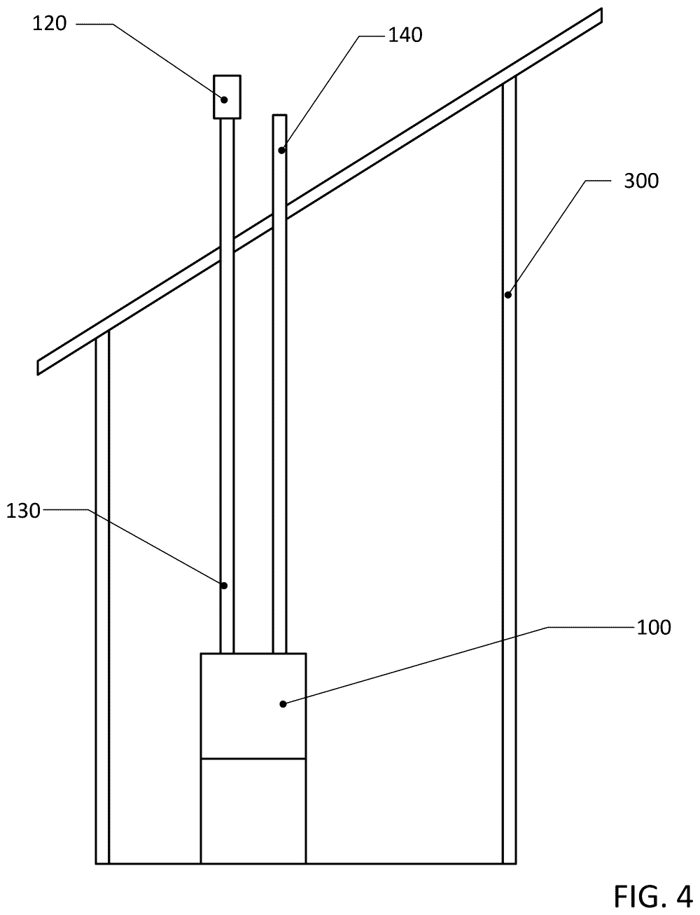

FIG. 4 illustrates a residential gas furnace 100 with an air intake pipe 130 disposed in a structure 300, and a flame arrestor 120 disposed outside of a structure 300, according to one or more embodiments of the present disclosure. In one or more embodiments, locating the inlet of the air intake pipe 130 outside the structure 300 is sufficient to mitigate potential flame propagation from the furnace without a flame arrestor 120. Thus, a flame arrestor 120 may not be needed if the intake of the air intake pipe is positioned outside of the structure 300. In that case, a refrigerant leak inside the structure 300 cannot commute refrigerant into the air intake pipe 130. One or more embodiments may include fittings, couplings, adapters, and directional components to direct the air intake pipe 130 to a suitable position outside the structure 300.

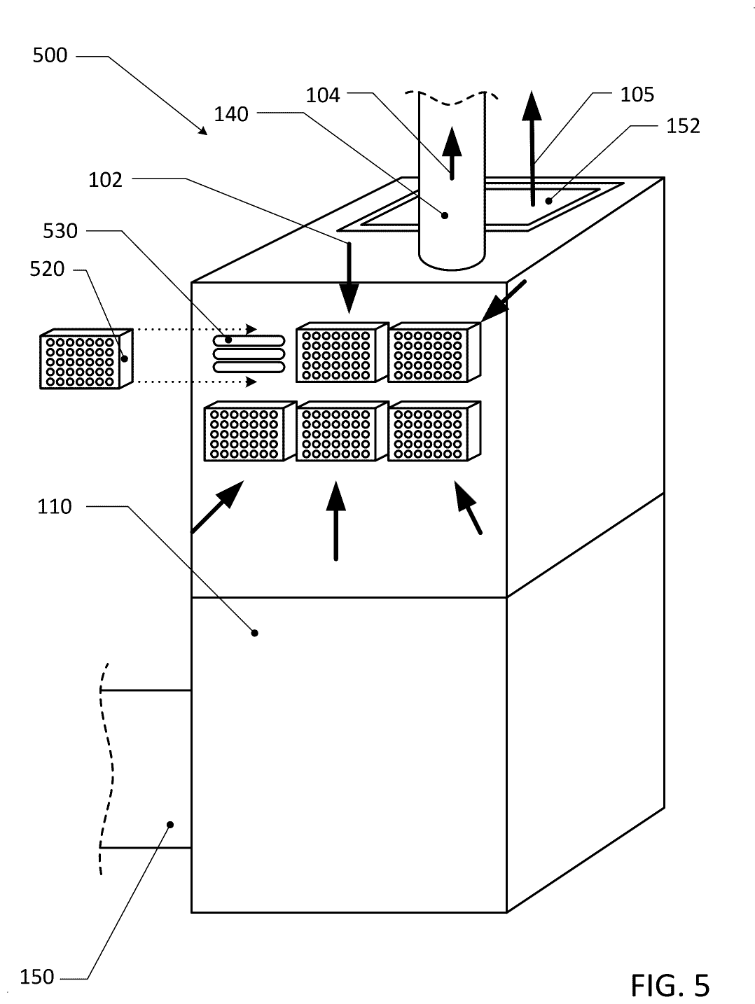

FIG. 5 illustrates a residential gas furnace 500 with multiple air intakes, such as louvers 530. The gas furnace 500 may also include other conventional structures, such as a housing 110, an exhaust flue 140, a circulation duct 150, a burner assembly (not shown), a heat exchanger (not shown), a fuel line, and other functional components. Combustion air 102 is drawn through the louvers 530 from the surrounding environment as a source of oxygen for combustion of a fuel, such as gas, in the furnace 500. The combustion of the fuel produces heated combusted flue gases that flow through the furnace heat exchanger. Circulation air 103 from a space being heated is drawn into the furnace 500 via the circulation intake duct 150 and flows over the heat exchanger, which outputs heated air 105 through the circulation outlet duct 152 to flow back into the heated space and cools the combusted flue gases 104. The combusted flue gases 104 then flow through the exhaust flue 140.

Furnaces are typically located near an air-conditioning system that uses a refrigerant to exchange thermal energy with air inside the space being conditioned. In the event gaseous refrigerant permeates the air surrounding the air-conditioning system and may be drawn into the furnace 100 through the louvers 530, the refrigerant in the drawn-in air 102 may ignite, resulting in a flame passing back through the louvers 530 and spreading to potentially flammable materials surrounding the furnace 500. To mitigate a flame spreading outside the furnace 500, one or more louver flame arrestors 520 may be installed over the louvers 530. The louver flame arrestor 520 may be constructed of aluminum, steel, or other metal, or a thermally resistant material such as a ceramic, hard silicone, or heat-resistant plastic.

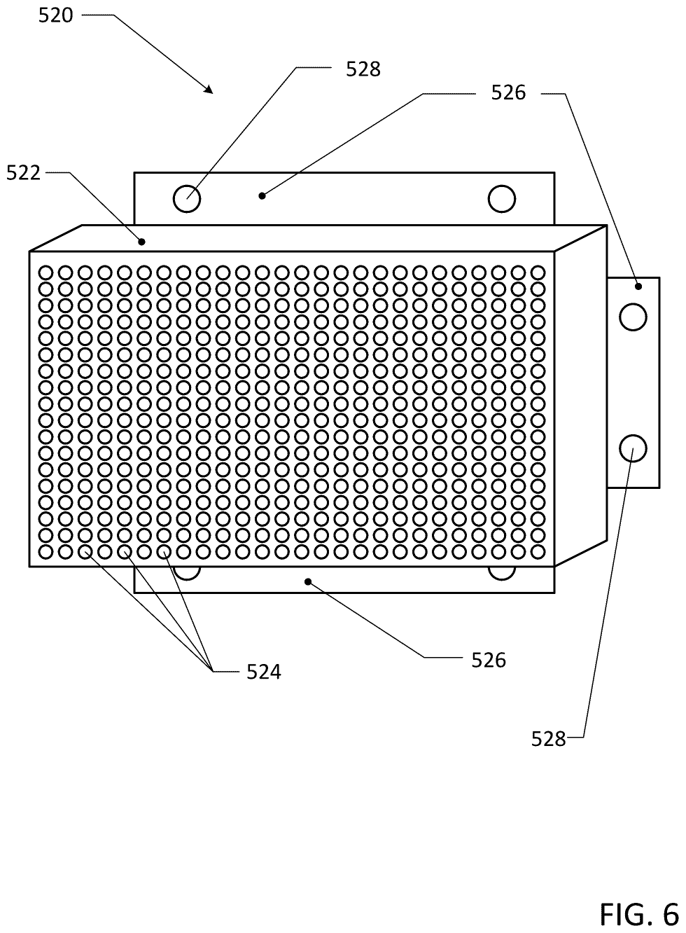

FIG. 6 illustrates an example louver flame arrestor 520 according to one or more embodiments of the present disclosure. The louver flame arrestor 520 consists of a louver cover 522, which may include a series of holes 524 disposed in a first face of the louver flame arrestor 520. The first face of the louver flame arrestor 520 may be perpendicular to a face of the furnace 500 when the louver flame arrestor 520 is installed on the furnace 100. In some embodiments, the holes 524 may be disposed through one or more faces of the louver flame arrestor 520 perpendicular to the face of the furnace 500 on which the louver flame arrestor 520 is mounted. The louver cover 522 protrudes outward, normal to a face of the furnace 500 when installed, to accommodate for any outward protrusion of the louvers 530. The holes 524 are configured to allow sufficient air movement through the louver flame arrestor 520 so as not to impair the combustion occurring in the furnace 100 during normal heating operations. The holes 524 are further configured to prevent a flame coming through the holes 524. The size and dispersal pattern of the holes 524 are determined based on the flowrate of air required to maintain combustion in the furnace 100 and the flammability of the refrigerant used in a nearby HVAC system.

In one or more embodiments, the diameter of the holes 524 may be in a range of 0.5 millimeters (mm) to 30 mm. In one or more embodiments the diameter of the holes 524 may be in a range of 1 mm to 10 mm. In one or more embodiments, the diameter of the holes 524 may be in a range of 2 mm to 7 mm. In one or more examples, such as for use with R-454B refrigerant, the diameter of the holes 525 is preferably less than 7 mm. In one or more examples, such as for use with R-32 refrigerant, the diameter of the holes 524 is less than 2.8 mm.

In one or more embodiments, a center-to-center distance between the holes 524, relative to the diameter of the holes 524 is in a range of 100% to 1000%. In one or more embodiments, the center-to-center distance between the holes 524, relative to the diameter of the holes 524 is in a range of 150% to 300%.

The louver flame arrestor 520 may include installation tabs 526 through which fastener holes 528 are formed. The louver flame arrestor 520 may be aligned over a louver 530 and may be secured to the housing 110 over a louver 530 via a self-tapping screw or other fastener, such as a rivet.

According to one or more embodiments, the louver flame arrestor 520 may be in the form of a kit. The kit may include one or more louver flame arrestors 520 and one or more fasteners, adhesives, gaskets, or sealants for the louver flame arrestor 520 to be installed on either a new or existing furnace.

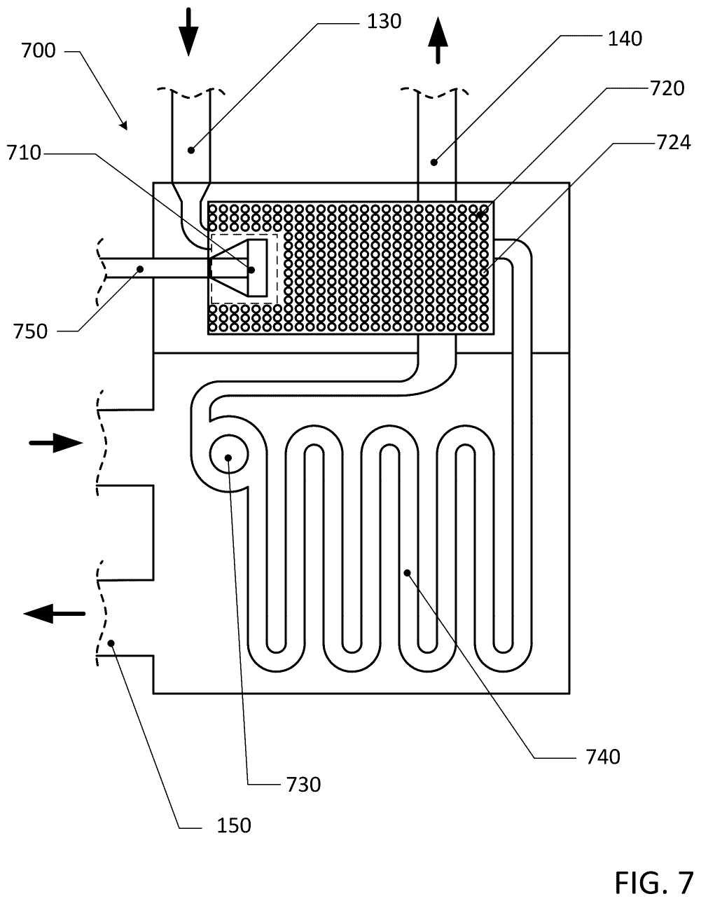

FIG. 7 illustrates a gas furnace 700 with a flame arresting burner enclosure 720, according to one or more embodiments. The furnace 700 includes burners 710 (e.g. gas burners), a fan 730, heat exchanger tubes 740, an air intake pipe 130, an exhaust flue 140, a fuel line 750 and circulation ducts 150. The flame arresting burner enclosure 720 may also be used as a replacement for a solid-walled burner enclosure. The flame arresting burner enclosure 720 surrounds the burners 710 and includes holes 724 disposed therethrough, which impede the propagation of flame.

The flame arresting burner enclosure 720 is configured to dispel any flame in the event of ignition of a refrigerant drawn into the furnace 700. That is, the flame is dispelled by the flame arresting burner enclosure 720 because the holes 724 allow for an increase in pressure resulting from the flame without inducing a backflow of flame out of the air intake 130, and without facilitating propagation of the flame outside of the burner enclosure 720.

The holes 724 are configured to allow sufficient air movement through the flame arresting burner enclosure 720 such that a rapid pressure increase due to a sudden ignition does not induce a backflow of the flame into the burners 710 and air intake pipe 130. The holes 724 are further configured to prevent the spread of a flame through the holes 724. The size and dispersal pattern of the holes 724 are determined based on the flowrate of air required to maintain combustion in the furnace 700 during normal heating operations and the flammability of the refrigerant used in a nearby HVAC system.

In one or more embodiments, the diameter of the holes 724 may be in a range of 0.5 millimeters (mm) to 30 mm. In one or more embodiments the diameter of the holes 724 may be in a range of 1 mm to 10 mm. In one or more embodiments the diameter of the holes 724 may be in a range of 2 mm to 7 mm. In one or more examples, such as for use with R-454B refrigerant, the diameter of the holes is preferably less than 7 mm. In one or more examples, such as for use with R-32 refrigerant, the diameter of the holes 724 is less than 2.8 mm.

In one or more embodiments, the center-to-center distance between the holes 724, relative to the diameter of the holes 724 is in a range of 100% to 1000%. In one or more embodiments, the center-to-center distance between the holes 724, relative to the diameter of the holes 724 is in a range of 150% to 300%.

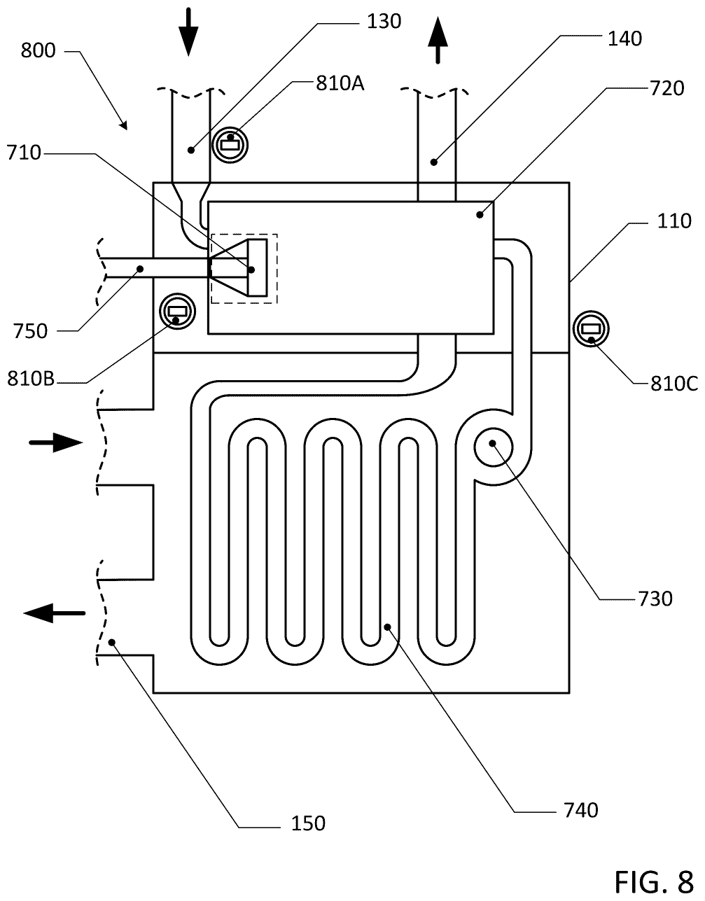

FIG. 8 illustrates a gas furnace 800, according to one or more embodiments. Shown in FIG. 8 are various furnace structures such as burners 710, a fan 730, heat exchanger tubes 740, an air intake pipe 130, an exhaust flue 140, a fuel line 750 and circulation ducts 150. The gas furnace 800 further includes refrigerant sensors 810A-C (generally or collectively, sensors 810). In one or more embodiments, the sensors 810 may be disposed on, near, or in the air intake pipe 130, within the furnace housing 110, proximately to the burners 710, in the burner enclosure 720, or in a combination of the above locations. The sensors 810 may be any suitable type of refrigerant sensor for detecting one or more types of refrigerant used by the air-conditioning system in the same structure in which the furnace is located. For example, the sensors 810 may be A2L refrigerant sensors.

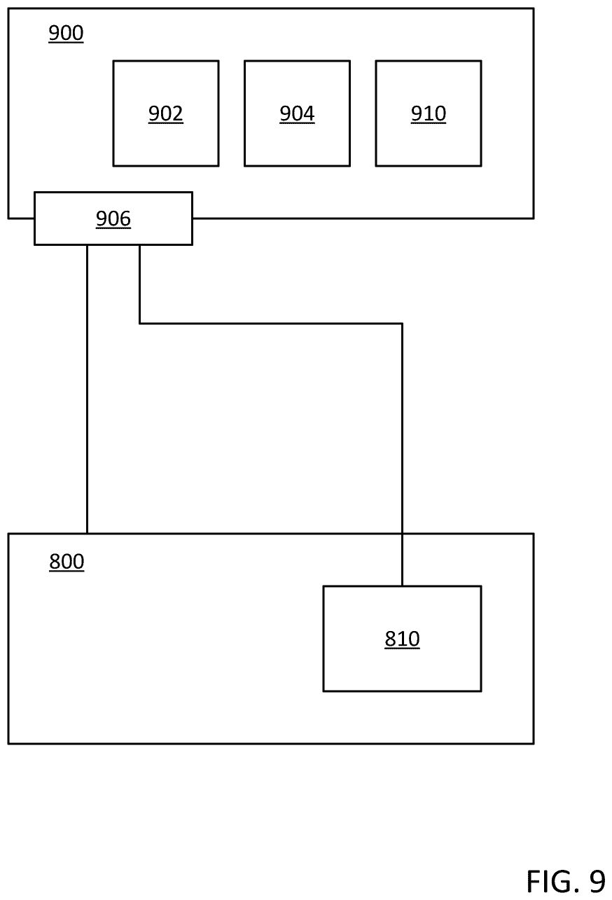

FIG. 9 illustrates a schematic of a control system 900 configured to interface with the gas furnace 800, according to one or more embodiments. The sensors 810 may be connected, electronically or otherwise, to the control system 900. In some examples the controller 900 may include a processor 902 and a memory 904, and interface with the furnace 800 and sensors 810 via a communications interface 916. In some examples, the controller may be capable of issuing a shutoff command to, or otherwise turning off one or more components of the furnace 800 or associated HVAC system, such as the burners 710. In the event that a sensor 810 detects refrigerant in the combustion air 102 of the furnace 800, the control system 900 may shut off the furnace 800, which may include turning off the burners 710 or the furnace 800 so that the refrigerant does not ignite, reducing the risk of a flare up or propagation of flame outside of the gas furnace 800. Some examples of the control system 900 and may include, or include a connection to, a thermostat 910. In the event that the thermostat 910 detects (e.g. via a thermometer, temperature sensor, thermocouple, or similar device, disposed in the furnace 800) a temperature above a predetermined threshold in the furnace 800, indicating a flare up or flame, the control system 900 may shut off the furnace 800, which may include turning off the burners 710 or the furnace 800 reducing the risk of propagation of flame outside of the gas furnace 800.

Although shown with a burner enclosure 720, it should be understood that the sensors 810 may be used with any of the flame arrestors discussed herein, including the flame arrestor 120 discussed with respect to FIGS. 1-4 and the louver flame arrestor 520 discussed with respect to FIGS. 5 and 6. Further, it should be understood that the sensors 810 may be installed on a furnace without a flame arrestor with a control system to prevent or reduce an occurrence of a flame propagating outside of the furnace.

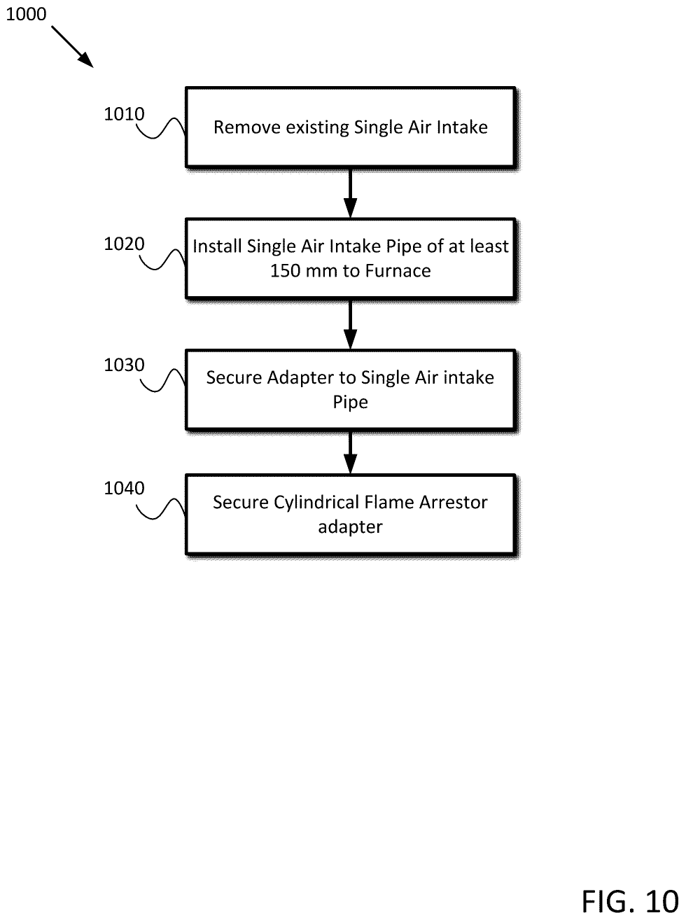

FIG. 10 illustrates a method 1000 for installing a flame arrestor on an existing gas furnace with a single air intake. At block 1010 of the method 1000, the existing single air intake is removed.

At block 1020 of the method 1000, a single air intake pipe is installed. In one or more examples, the single air intake pipe is of a length greater than 150 mm. The single air intake pipe may have one of any thicknesses and is preferably of the same diameter as the previously removed single air intake on the furnace.

At block 1030 of the method 1000, an adapter is secured to the single air intake pipe. The adapter is configured to attach to the single air intake pipe on one side and to connect to a flame arrestor on another side. The adapter may be configured to secure via a threaded connection or by nesting the components and securing by an adhesive. In some embodiments, the adapter may be part of the single air intake pipe.

At block 1040 of the method 1000, the flame arrestor is attached to the adapter (or the single air intake pipe). The flame arrestor may be connected to the adapter (or single air intake pipe) via a threaded connection, adhesive, or other sufficient connection to reduce prevent intake air from leaking therethrough. The flame arrestor may be the same or similar to the flame arrestor 120 described in FIG. 2.

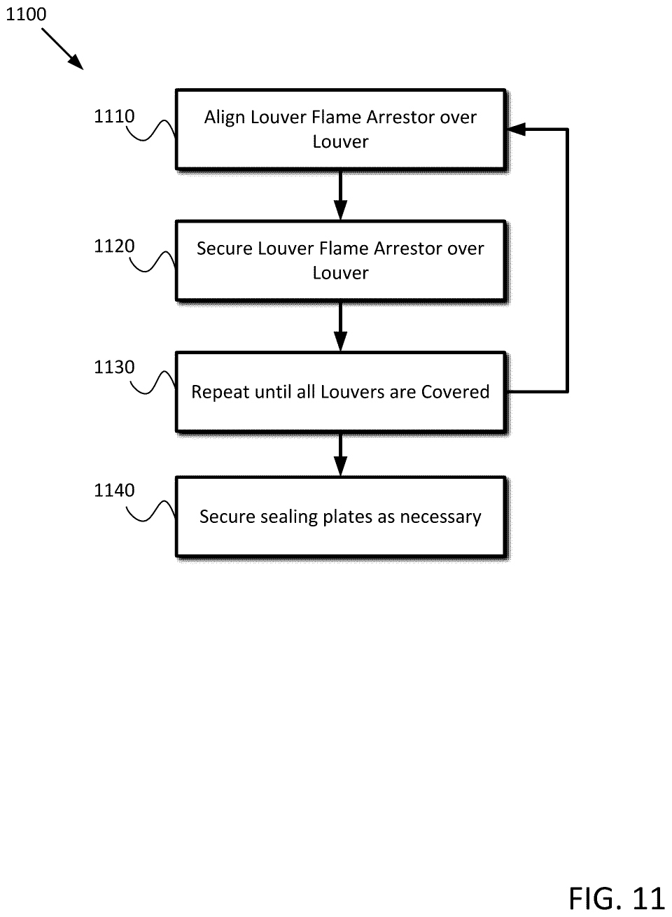

FIG. 11 illustrates a method 1100 for installing louver flame arrestors on an existing gas furnace with one or more louver air intakes. At block 1110, a louver flame arrestor is aligned with a louver, such that the louver flame arrestor covers the entire louver. The louver flame arrestor may be the same or similar to the louver flame arrestor 520 described in FIG. 6.

At block 1120 of the method 1100, the louver flame arrestor is secured over the louver. In one or more examples, the louver flame arrestor includes tabs by which the louver flame arrestor can be secured to the housing of the gas furnace with various fasteners, such as screws, bolts, and rivets.

At block 1130 of the method 1100, blocks 1110 and 1120 are repeated until all the louvers of the gas furnace are covered by louver flame arrestors.

At block 1140 of the method 1100, any additional openings or holes in the furnace housing may be closed or sealed with various sealing plates, which may be manufactured to accommodate various designs of existing or new furnaces.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims. For example, certain embodiments disclosed here envisage usage with a powered fan rather than an inducer fan, or no fan at all. Moreover, the rotating equipment (e.g., motors) and valves disclosed herein are envisaged as being operable at specified speeds or variable speeds through inverter circuitry, for example. Moreover, the internal and external communication of the furnace may be accomplished through wired and or wireless communications, including known communication protocols, Wi-Fi, 802.11 (x), Bluetooth, to name just a few.

What is claimed is:

1. A gas furnace, comprising:
a housing comprising at least one air intake configured to receive an air for combustion with a fuel in the housing; and
at least one flame arrestor connected to the air intake and comprising holes configured to arrest a flame from the housing propagating out of the air intake.

2. The gas furnace of claim 1, wherein the at least one flame arrestor is connected to an intake end of an air intake pipe connected to the air intake.

3. The gas furnace of claim 2, wherein the holes are provided about a rounded surface of the flame arrestor.

4. The gas furnace of claim 2, wherein the at least one flame arrestor is attached to the air intake pipe via an adapter, and the at least one flame arrestor comprising a cap distal to the adapter.

5. The gas furnace of claim 4, wherein the cap does not include holes, and the holes are oriented perpendicular to gravity.

6. The gas furnace of claim 2, wherein a length of the air intake pipe is at least 150 millimeters and above a Low Flammable Limit (LFL) height.

7. The gas furnace of claim 1, wherein the at least one air intake comprises a louver and the at least one flame arrestor comprises a louver flame arrestor connected to the louver.

8. The gas furnace of claim 7, wherein the holes are provided on a louver cover of the louver flame arrestor.

9. The gas furnace of claim 8, wherein the holes are provided on a first face of the louver cover perpendicular to a face of the housing.

10. The gas furnace of claim 7, wherein the gas furnace is disposed in a structure, and the at least one flame arrestor is disposed outside of the structure.

11. The gas furnace of claim 1, wherein a diameter of the holes is between 0.5 millimeters to 30 millimeters and a center-to-center distance between the holes relative to the diameter of the holes is in a range between 150% to 300%.

12. A gas furnace comprising:
a housing comprising an air intake;
at least one burner in the housing; and
at least one flame arresting burner enclosure, each flame arresting burner enclosure is around each of the at least one burner, the flame arresting burner enclosure comprising holes configured to arrest a flame propagating out of the burner.

13. The gas furnace of claim 12, further comprising a refrigerant sensor disposed on, near, or in the housing and configured to detect a refrigerant in or near the housing.

14. The gas furnace of claim 13, further comprising a processor operable to receive a signal from the refrigerant sensor and shut off operation of the at least one burner.

15. The gas furnace of claim 12, wherein a diameter of the holes is between 0.5 millimeters to 30 millimeters, and a center-to-center distance between the holes relative to the diameter of the holes is in a range between 150% to 300%.

16. A method comprising:
securing at least one flame arrestor to an air intake of a gas furnace; and
arresting a flame propagating out of the air intake with holes of the flame arrestor.

17. The method of claim 16, further comprising:
removing an existing air intake; and
installing an air intake pipe on the air intake, and the air intake pipe extends outwardly from a housing of the gas furnace.

18. The method of claim 17, further comprising:
securing an adaptor to an end of the air intake pipe; and
attaching the flame arrestor to the adaptor.

19. The method of claim 16, further comprising:
aligning the flame arrestor over a louver of the air intake;
covering the louver with the flame arrestor; and
securing the flame arrestor to the gas furnace over the louver.

20. The method of claim 19, further comprising securing the flame arrestor to a housing of the gas furnace via installation tabs of the flame arrestor.
